(19) United States
(12) Patent Application Publication
(10) Pub. No.: US 2006/0203106 A1
(43) Pub. Date: Sep. 14, 2006

(54) Methods and apparatus for retrieving data captured by a media device

(76) Inventors: Joseph P. Lawrence, Marion, IL (US); Cindy L. Lawrence, Marion, IL (US); Paul L. Lawrence, Marion, IL (US); Nathan E. Lawrence, Marion, IL (US)

Correspondence Address: AKERMAN SENTERFITT, P.O. BOX 3188, WEST PALM BEACH, FL, 33402-3188, US

(21) Appl. No.: 11/079,374

(22) Filed: Mar. 14, 2005

(51) Int. Cl. H04N 5/76

(52) U.S. Cl. 348/231.99

(57) ABSTRACT

Embodiments of the present invention relate generally to methods and apparatus for retrieving data captured by a media device. For example, a method (300) for securely retrieving data captured by a media device (100) includes the step of a supplier offering (302) a media device to a third party. The third party captures (304) one or more media types with the media device, and contacts (306) the supplier for processing a selection of the one or more media types. The supplier provides (308) a key (200-290) to enable access to the one or more media types stored in the media device, accesses (312) the selection of the one or more media types, and processes (314) said selection. The capturing, contacting, providing, accessing and processing steps can be applied two or more use-cycles unconstrained by a supplier of said device. Additional embodiments are disclosed.

### FIELD OF THE INVENTION

This invention relates generally to media devices, and more particularly to methods and apparatus for retrieving data captured by a media device.

### BACKGROUND OF THE INVENTION

There are many forms of media devices for capturing recordable media types. Examples of media devices include still picture cameras, video camcorders, GPS receiving devices that monitor drive routes, instrumentation for recording health or research data, and so on.

From these devices, multiple business applications have been implemented. For example, digital single use cameras have recently been introduced. These cameras are sold by retailers at a nominal price requiring the consumer to return to the retailer for photo processing. Once the camera is delivered for photo processing, it is not returned to the consumer—hence, the “single-use” attribute. Reference WO 2003/024083 entitled, “Recyclable, Digital One Time Use Camera,” (incorporated herein by reference) further teaches that a single use digital camera can be reset physically or electrically by the retailer or a consumer after “purchasing” reset tokens so as to restart a new use cycle after a previous one has expired.

The foregoing business transactions establish a loyalty program between the consumer and the retailer, which adds to the retailer's long-term profitability through photo-processing along with anchoring the consumer for potential future purchases of other goods offered by the retailer at its place of business. As a business model, single use digital cameras parallel the business case for “film-based” disposable cameras. Film-based single use cameras are offered by multiple vendors differing in method, but effecting the same business model. Film-based disposable cameras have been commercially successful in part because consumers readily understand that photographic film has a single use cycle.

Most consumers are readily aware, however, that digital cameras enjoy the benefit of photographic memory with unlimited use cycles. For this reason, many consumers do not like the single use limitation of the aforementioned digital camera. Additionally, consumers do not like a requirement to purchase reset tokens in order to extend the use of a single-use digital camera.

From the mass distribution of media devices, a need arises to develop a new means for commercializing these devices.

### SUMMARY OF THE INVENTION

Embodiments in accordance with the invention provide methods and apparatus for retrieving data captured by a media device.

In a first embodiment of the present invention, a method is provided for securely retrieving data captured by a media device. The method includes the step of a supplier offering a media device to a third party. The third party captures one or more media types with the media device, and contacts the supplier for processing a selection of the one or more media types. The supplier provides a key to enable access to the one or more media types stored in the media device, accesses the selection of the one or more media types, and processes the selection of the one or more media types. The capturing, contacting, providing, accessing and processing steps are applied for a plurality of use-cycles unconstrained by a supplier of said device.

In a second embodiment of the present invention, a media device has a media module for capturing one or more media types, a memory coupled to the media module for securely storing the captured one or more media types, a media port coupled to the memory for providing an alternate device access to a selection of the one or more securely stored media types after detecting a valid security key, and a housing assembly for carrying the components of the media device, wherein the aforementioned components of the media device have a plurality of use-cycles unconstrained by a supplier of said device.

In a third embodiment of the present invention, a media device has a media module, a media port, a memory, a processor for controlling operation of the media module, the media port and the memory. The media device further includes a housing assembly for carrying the components of the media device. The processor is programmed to capture one or more media types with the media module, store the one or more media types in the memory, restrict access to retrieve the one or more media types in the memory, detect a valid security key at the media port, provide an alternate device access to the selection of the one or more media types in the memory after determining the security key is valid, and apply the foregoing steps for a plurality of use-cycles unconstrained by a supplier of said device.

In a fourth embodiment of the present invention, a media key has a first port for enabling access to one or more media types stored in a media device having a plurality of use-cycles unconstrained by a supplier of said device, and a second port for supplying the one or more media types.

In a fifth embodiment of the present invention, a media device has a computer-readable storage medium. The computer storage medium includes computer instructions for capturing one or more media types with a media module of the media device, storing the one or more media types in a memory of the media device, accepting a key at a media port of the media device to enable access to a selection of the one or more media types, supplying an alternate device coupled to the media port the selection of the one or more media types, and applying the foregoing steps for a plurality of use-cycles unconstrained by a supplier of said device.

In a sixth embodiment of the present invention, a media key includes a computer-readable storage medium. The storage medium has computer instructions for enabling through a first port of the media key access to one or more media types stored in a media device having a plurality of use-cycles unconstrained by a supplier of said device, and supplying through a second port of the media key the one or more media types supplied by the media device

In a seventh embodiment of the present invention, a method is provided for securely retrieving data captured by a media device. The method includes the steps of a supplier, offering to a third party a media device. The third party captures one or more media types with the media device. The one or more media types include recordable information from one or more information sources excluding still image information. The third party contacts the supplier to process a selection of the one or more media types. The supplier provides a key to enable access to the one or more media types stored in the media device, accesses the selection of the one or more media types, and processes the selection of the one or more media types.

In an eighth embodiment of the present invention, a media device is provided that includes a media module for capturing one or more media types. The one or more media types comprise recordable information from one or more information sources excluding still image information. The media device further includes a memory coupled to the media module for securely storing the captured one or more media types, a media port coupled to the memory for providing an alternate device access to a selection of the one or more securely stored media types after detecting a valid security key, and a housing assembly for carrying the components of the media device.

In a ninth embodiment of the present invention, a media device includes a computer-readable storage medium. The storage medium has computer instructions for capturing one or more media types with a media module of the media device. The one or more media types include recordable information from one or more information sources excluding still image information. The storage medium further includes computer instructions for storing the one or more media types in a memory of the media device, accepting a key at a media port of the media device to enable access to a selection of the one or more media types, and supplying an alternate device coupled to the media port the selection of the one or more media types.

In a tenth embodiment of the present invention, a method is provided for retrieving data captured by a media device. The method includes the step of a supplier offering to a third party a media device. The method further includes the steps of the third party capturing one or more media types with the media device, wherein the one or more media types comprise recordable information from one or more information sources excluding still image information, and contacting the supplier to process a selection of the one or more media types. The method includes the steps of the supplier accessing the selection of the one or more media types, and processing the selection of the one or more media types, wherein a portion of the foregoing steps is limited to a single use cycle.

In an eleventh embodiment of the present invention, a media device includes a media module for capturing one or more media types, wherein the one or more media types comprise recordable information from one or more information sources excluding still image information. The media device further includes a memory coupled to the media module for storing the captured one or more media types, a media port coupled to the memory for providing an alternate device access to a selection of the one or more stored media types, and a housing assembly for carrying the components of the media device, wherein a portion of the foregoing components are limited to a single use cycle.

In a twelfth embodiment of the present invention, a media device has a computer-readable storage medium. The storage medium includes computer instructions for capturing one or more media types with a media module of the media device, wherein the one or more media types comprise recordable information from one or more information sources excluding still image information. The storage medium further includes computer instructions for storing the one or more media types in a memory of the media device, and supplying an alternate device coupled to the media port a selection of the one or more media types, wherein a portion of the foregoing computer instructions are limited to a single use cycle.

In a thirteenth embodiment of the present invention, a method for securely retrieving data captured by a media device is provided. The method includes the steps of a supplier offering to a third party a media device. The method continues with the step of the third party capturing one or more media types with the media device, and contacting the supplier to process a selection of the one or more media types. The method is furthered with the supplier providing a key to enable access to the one or more media types stored in the media device, accessing through the key the selection of the one or more media types without modifying said media types while traversing said key, and processing at a final processing means coupled to the key the selection of the one or more media types.

In a fourteenth embodiment of the present invention, a media device includes a media module for capturing one or more media types, a memory coupled to the media module for securely storing the captured one or more media types, a media port coupled to the memory and to a key for providing a final processing means coupled to the key access to a selection of the one or more securely stored media types without modifying said media types while traversing said key, and a housing assembly for carrying the components of the media device.

In a fifteenth embodiment of the present invention, a media device has a computer-readable storage medium. The storage medium has computer instructions for capturing one or more media types with a media module of the media device, storing the one or more media types in a memory of the media device, accepting a key at a media port of the media device to enable access to a selection of the one or more media types without modifying said media types while traversing said key, and supplying the final processing means coupled to the key the selection of the one or more media types.

In a sixteenth embodiment of the present invention, a media key has a first port for enabling access to one or more media types stored in a media device, and a second port for supplying the one or more media types to a final processing means without modifying the one or more media types.

In a seventeenth embodiment of the present invention, a media key has a computer-readable storage medium. The storage medium has computer instructions for enabling through a first port of the media key access to one or more media types stored in a media device, and supplying through a second port of the media key the one or more media types supplied by the media device to a final processing means without modifying the one or more media types.

### BRIEF DESCRIPTION OF THE DRAWINGS

FIG. 1 depicts a media device according to an embodiment of the present invention;

FIGS. 2-7 depict alternate embodiments of the media device according to the present invention;

FIGS. 8-12 and 18-19 depict alternate embodiments of a media key according to the present invention;

FIGS. 12-16 and 18-19 depict alternate embodiments for coupling the media key, the media device, and an alternate device according to the present invention; and

FIGS. 20-22 depict flowcharts with alternate embodiments of a method for utilizing the media device according to the present invention.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

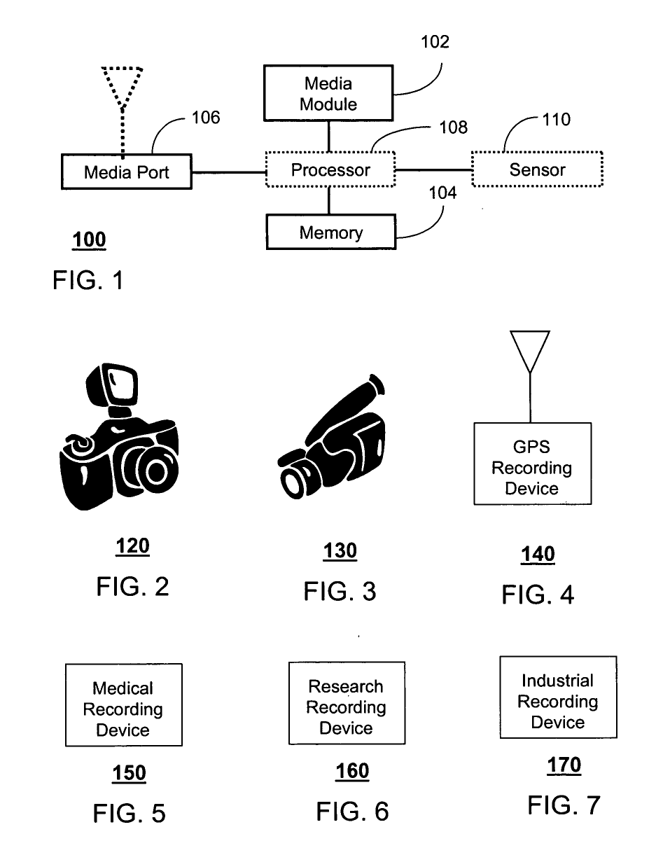

FIG. 1 depicts a media device 100 according to an embodiment of the present invention. In a first embodiment, the media device 100 comprises a media module 102, a memory 104, and a media port 106. The media module 102 comprises any conventional technology that captures recordable information from one or more information sources such as, but not limited to, location information, environmental information, medical information, public information, instrumentation information, commercial information, audio information, still image information, moving image information, still image information combined with audio information, or moving image information combined with audio information.

The media module 102 can comprise for instance one or more conventional recordable devices such as an instrument for monitoring location, a measurement instrument, a sensing instrument, a health monitoring instrument, a commercial operations monitoring instrument, a public monitoring instrument, an audio capture instrument, an image capture instrument, and an image combined with audio capture instrument. A limited number of examples of such conventional instrumentations are shown in FIGS. 2-7.

The memory 104 includes conventional storage technology for capturing said recordable information. For example, the memory 104 can include one or more non-volatile memory components such as conventional Flash memory, magnetic tape media, CD media, DVD media, combinations thereof, or any other conventional writeable non-volatile memory. The memory 104 can also include one or more volatile memories such as RAM (Random Access Memory) or other conventional volatile memory. Although not as practical, the present invention can be applied to volatile memories for storing recordable content of the media module 102 so long as power is supplied to said memory for a period of time sufficient to access said stored content. In a first embodiment the memory 104 can be inaccessible in a housing assembly of the media device 100. Alternatively, the memory 104 can be removable. Each of these embodiments will be explained below.

The media port 106 can utilize conventional technology for providing an alternate device access to the content captured by the memory 104. Access by way of said port 106 can be through direct physical coupling, wireless coupling, or combinations thereof. Physical coupling can be accomplished with any conventional means for physical coupling such as, for example, a conventional connector for supplying electrical signals from the memory 104. Wireless coupling can be similarly accomplished with any conventional short-range or long-range wireless technology such as optical infrared technology, Bluetooth RF (Radio Frequency) technology, variants of IEEE 802.11 RF technology, and cellular technology just to name a few. Accordingly, the media port 106 can include any of the aforementioned technologies singly or in combination or modifications thereof to provide an alternate device access to the content of memory 104.

In a supplemental embodiment, the media device 100 can further include a processor 108 comprised of conventional technology such as one or more microprocessors and/or DSPs (Digital Signal Processors) for controlling operations of the components of the media device 100. For instance, the processor 108 can be programmed with computer instructions to capture one or more media types with the media module 102, store the one or more media types in the memory 104, restrict access to retrieve the one or more media types in the memory 102, detect a valid security key (as will be described below) at the media port 106, and provide an alternate device (see references 10-14 of FIGS. 13-16 and 17-18) access to the selection of the one or more media types in the memory 104 after determining the security key is valid.

Additionally, the media device 100 can include a conventional sensor 110 for detecting events that can trigger disablement of the media device 100. The sensor 110 can be in whole or in part designed from a computer program and/or conventional hardware technology capable of sensing events such as, but not limited to, altering a housing assembly 101 of the media device 100, accessing the memory 104 with an invalid security key, exceeding a predetermined use period set by the supplier of the media device 100, violating use guidelines set by the supplier, and/or receiving a signal from the supplier to disable the media device 100. The processor 108 and/or the sensor 110 can include computer instructions for detecting, managing and controlling any of the aforementioned events.

The term disabling as used above means rendering the media device 100 inoperable. In operability can mean preventing the media device 100 from performing normal operations such as, for example, preventing powering of the device 100, preventing the media module 102 from capturing and storing in the memory 104 media type information from any of the aforementioned information sources, and/or any other conceivable means to prevent the third party from performing desirable functions on the media device 100.

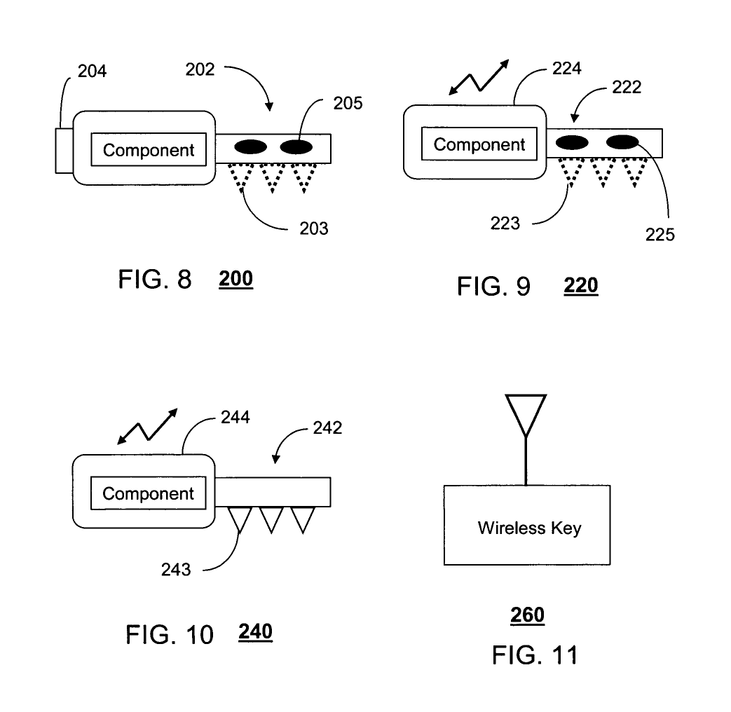

FIGS. 2-7 depict alternate embodiments 120-170 of the media device 100 with corresponding housing assemblies according to the present invention. In a first embodiment, the media device 100 can represent a still image capture instrument 120 such as a digital camera. In this embodiment, the media module 102 comprises a conventional digital image sensing device for capturing a still image and for storing said image in the memory 104. The digital camera can have any number of enhancement features such as programmable viewing of still images on an LCD (Liquid Crystal Display), deletion of images, adjusting light settings according to environment conditions, a variety of removable zoom lenses, removable light filters, and so on. It is important to note, however, that although content can be deleted in the memory 104, content cannot be retrieved physically by removal of, for example, the memory 104, which is made inaccessible by the housing assembly 101 of the media device 100. Similarly, content cannot be retrieved from the memory 104 without the use of a security key (as will be illustrated in FIGS. 8-18) for enabling access to said securely stored information content.

FIG. 3 illustrates an alternative embodiment for the media device 100 represented by a video camcorder 130 for capturing moving and/or still images. In this embodiment, the media module 102 utilizes conventional technology typically used in a video camera. Moreover, the captured information content is stored securely in the memory 104 and can only be accessed once enabled by the aforementioned security key. FIGS. 4-7 provide yet other alternate embodiments of the media device 100 including a conventional GPS receiver 140 for monitoring, for example, drive routes, a medical recording device 150 (e.g., heart monitor), a research recording device 160 that measures, for example, environment information, experiments in progress, etc., and a industrial recording instrument 170 for recording, for example, manufacturing information, recording images of employee behavior, etc. These alternate embodiments of the media device 100 represent instrumentations for commercial, public, or industrial use that can record any form of useful information sensed by conventional technology embedded in the media module 102 and stored in the memory 104. As before, the content cannot be retrieved for processing without a security key.

The terms “media key”, “security key”, “key”, “wireless key”, and “security information” are used interchangeably through the rest of the description. The media key comprises a first port for enabling access to one or more media types stored in the memory 104 of the media device 100. The media key further includes a second port for supplying the one or more media types to an alternate device like a conventional photo processor (where the media device is embodied as a camera 120) for developing images on commercial photographic paper.

The first port of the media key can have numerous embodiments as will be illustrated in FIGS. 8-11 and 18-19. For instance, the first port of the media key can be represented by a keyed implement (see references 203, 223, 243 and 283 of FIGS. 8-10 and 12) for physically engaging and unlocking a corresponding locking implement of the media device 100. In the present context, the term unlocking can be realized by way of physical or logical means. For example, unlocking could be represented by the release of a compartment door of the media device 100 that prevents access to a connector coupled to the memory 104 for retrieval of stored content. Alternatively, unlocking can be represented by a logical enablement such as electrically enabling a connector coupled to the memory 104 once the keyed implement unlocks the corresponding locking implement of the media device 100.

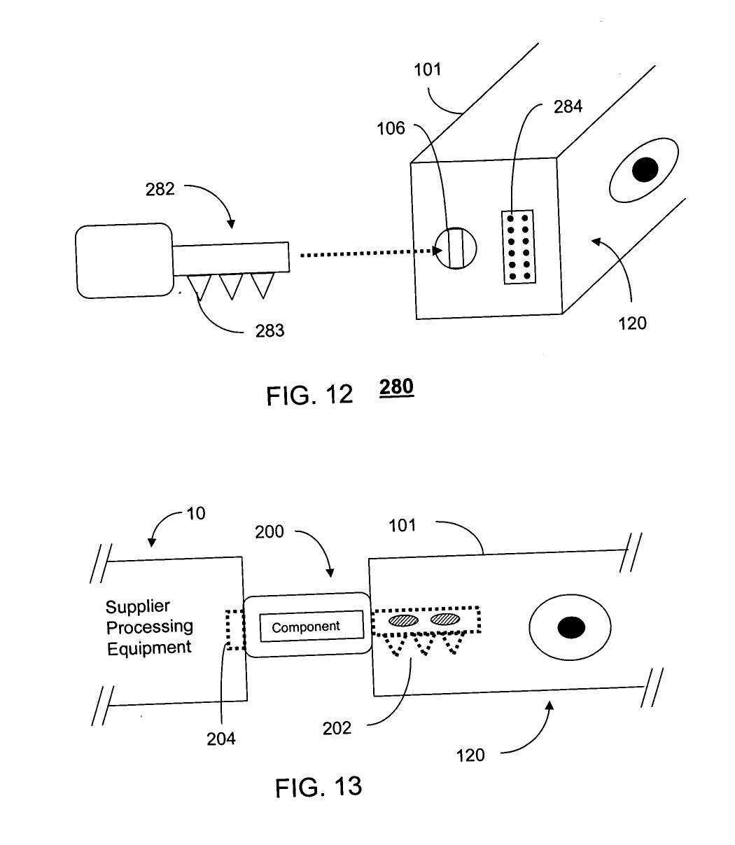

A keyed implement can be a conventional key (similar to a house key-see FIG. 12) for engaging with a corresponding mechanical locking implement. The locking implement can be in whole or in part a portion of the media port 106 of the media device 100. Alternatively, the first port of the media key can be represented by an implement having one or more electrical components with exposed contacts for providing security information to the media device 100 upon physically engaging with corresponding electrical contacts of the media device 100 (see FIGS. 8-9). A component embedded in the media key can be represented by a conventional memory storing security information with or without the assistance of a processor for controlling said exchange with the media device 100. For additional security, the security information can be encrypted.

In another embodiment, the first port of the media key can be represented by an implement having one or more electrical components for providing wireless security information to the media device 100 upon physically engaging and unlocking a corresponding locking implement of the media device 100 (see FIGS. 9-10). In this embodiment, the electrical components can include conventional wireless technology for wirelessly receiving the contents of the memory 104, and for wirelessly conveying said contents to an alternate device. The implement can enable the wireless transfer by unlocking the corresponding implement of the media device 100. Said locking implement can be part of the media port 106 which can serve in part to detect a keyed mechanical engagement.

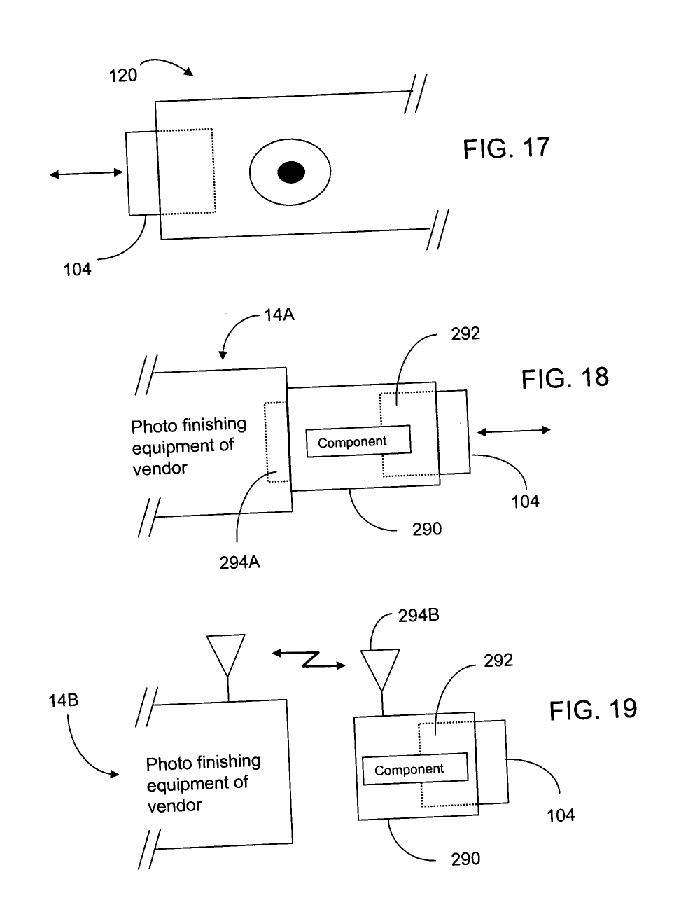

In yet another alternate embodiment, the first port of the media key can be represented by a wireless key interface for supplying the media port 106 of the media device 100 wireless security information (see FIG. 11). As before, the security information can be encrypted to avoid inadvertent access to the key. Once the security information is validated, the contents of the memory 104 can be retrieved wirelessly from the media port 106. In another embodiment, the first port of the media key can be represented by a proprietary undisclosed interface that couples to a removable memory 104 also having an undisclosed proprietary interface (see FIGS. 18-19).

It should be evident to an artisan with skill in the art that the first port of the media key can be represented by numerous embodiments consistent with the scope and spirit of the claimed invention. It would also be obvious to the artisan that the alternate embodiments of the first port described above are illustrative and not all inclusive of the embodiments possible for the first port of the media key.

The second port of the media key can also have numerous embodiments. For instance the second port can be an integral part of the media device 100 (as will be shown in FIG. 12), or can be an integral part of the media key (see references 204 and 294A of FIGS. 8 and 18, respectively). Moreover, the second port can have an industry-wide standard physical form factor with an electrical interface for coupling to an alternate device (see FIGS. 13 and 18). The form factor and the electrical interface can include, but is not limited to, an SD (Secure Digital) interface, a MMC (Multi Media Card) interface, a Smart Media card interface, a CompactFlash card interface, a TransFlash card interface, a USB (Universal Serial Bus) interface, a FireWire interface, and an Ethernet interface. It will be appreciated by an artisan with skill in the art that there are an indefinite number of present and future standard interfaces applicable to the present invention. Accordingly, said interfaces are contemplated to be within the scope and spirit of the claims described herein. The electrical functions provided by said electrical interfaces can be integrally part of the media key or supplied as electrical signals from the media port 106. Alternatively, the second port can be a wireless interface with conventional wireless technology built into the media key (see FIGS. 9-11 and 19).

FIGS. 8-12 and 18-19 illustrate embodiments 200-290 of the media key just discussed. In FIG. 8, the media key 200 has a first port 202 with electrical contacts 205 coupled to a component embedded in the media key 200. In a supplemental embodiment, the first port can further include keyed elements 203 for engaging with media port 106. The media key 200 further has a second port 204 which can be represented by any of the aforementioned industry-wide standard form factors and electrical interfaces. The component in this embodiment can be a pass-through connector coupling the electrical contacts 205 and the second port 204.

FIG. 13 illustrates a coupling technique for the media key 200, the media device 100 (embodied as a camera 120), and a processing equipment of the supplier. In this illustration, the supplier's processing equipment 10 is physically-coupled to the second port 204 of the media key 200, while the first port 202 is coupled to the camera 120. The supplier's processing equipment 10 can be a conventional photo processor for developing digital images stored in a JPEG (Joint Photographic Experts Group) format. The second port 204 utilizes a known form factor (e.g., SD) so that it can directly couple to the supplier's processing equipment 10 without redesign. That is, the supplier can use processing equipment 10 for consumers who supply their own conventional media cards such as an SD card, and for consumers who utilizes a media device 100 as illustrated in FIG. 13.

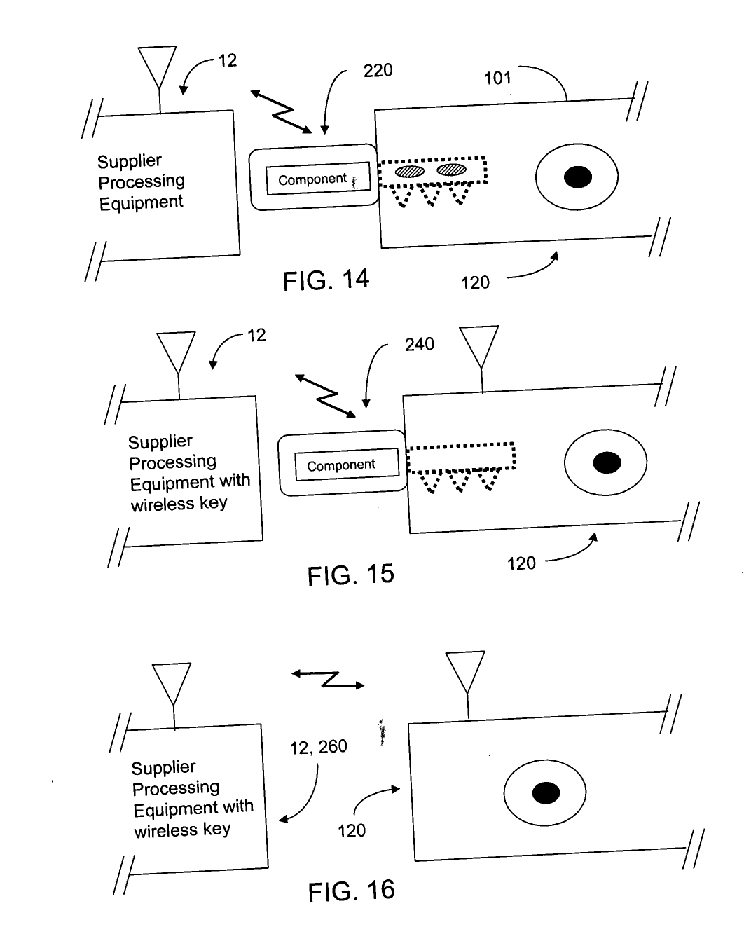

FIG. 9 illustrates an alternate embodiment 220 of the media key. The first port 222 includes electrical contacts 225 coupled to a component. In a supplemental embodiment, keyed elements 223 with notches and grooves can also be used for engaging with the media port 106. The component includes conventional technology for receiving electrical signals from the memory 104 through contacts 225, and conveys said signals wirelessly on the second port 224 to an alternate device. Additionally, the component supplies the media port 106 security information for enabling access to the memory 104. An alternative to providing security information electrically would be for the keyed elements 223 to serve as a to trigger for the media port 106 to enable access to the memory 104 once the key elements 223 are determined to be valid. FIG. 14 illustrates the operation of embodiment 220 of the media key with a supplier's wireless processing equipment 12.

FIG. 10 illustrates an alternate embodiment 240 of the media key. In this embodiment, the first port 242 has keyed elements 243 with no electrical contacts. As in the previous embodiment, the keyed elements 243 can be used by the media port 106 to enable access to the memory 104 once said elements 243 are determined to be valid. The second port 244 comprises a component for wireless communication with the alternate device 12 and media port 106 capable of wireless communication. The component can be used to supply coded security information to the media port 106 for enabling access to the memory 104 in lieu of or in addition to validating the keyed elements 243. FIG. 15 illustrates the operation of embodiment 240 of the media key with a supplier's wireless processing equipment 12.

FIG. 11 illustrates an alternate embodiment 260 of the media key represented as a wireless key. In this embodiment, the first and second ports are wireless. Moreover, the wireless key can be embedded in the supplier's processing equipment 12 as shown in FIG. 16. Wireless communication can be short-range (e.g., 802.11) or long-range (e.g., cellular) according to the technologies described earlier.

FIG. 12 illustrates yet another embodiment 280 of the media key. In this embodiment, the first port 282 is represented by a conventional key with keyed elements 283 for engaging a locking implement of the media port 106. The second port 284 of the media key is an integral part of the media device 100. In this illustration, the second port 284 is a conventional connector for coupling to the supplier's processing equipment (not shown). Alternatively, the second port can be a wireless interface. In either case, the second port 284 is disabled until the first port of the media key properly engages with the locking implement of the media port 106. Upon validation, the second port is activated for accessing the content stored by the memory 104.

FIGS. 18-19 illustrate additional embodiments 290 of the media key. In these embodiments, the media port 106 is an integral part of the memory 104, which can be inserted in the media device 100 and removed from the media device 100 as shown in FIG. 17. The media port 106 comprises an undisclosed interface for coupling to an undisclosed interface of the first port 292 of the media key 290. The undisclosed interfaces can be electromechanical interfaces known only to the proprietor of said media key. The first port 292 of the media key can be a simple proprietary rearrangement of signals of a standard interface such as Compact Flash.

These signals are then reordered by the component shown therein so that the second port 294A can support a standard Compact Flash interface. The component in this instance is a conventional pass-through connector coupling the electrical contacts of the proprietary interface of the media port 106 of the memory 104 to the standard Compact Flash interface of the second port 294A. Alternatively, the component can include conventional wireless technology to interpret signals from the proprietary interface and relay the contents of the memory 104 to the supplier's photo finishing equipment 14B via a wireless second port 294B conforming to a standard over-the-air protocol (e.g., Bluetooth).

Alternatively, the first port 292 can include conventional circuitry in the component, which can compare and match a secure ID provided by the memory 104 to a validation ID stored in the component before enabling the second port 294 to supply the one or more media types stored in the memory 104. In this embodiment, the component can be represented a pass-through connector with a second port 294A having an industry-standard interface as noted earlier, or with a wireless second port 294B. In retail settings, an ID matching technique such as this can be used for security purposes as well as to distinguish between retailers without redesigning the media key 290. That is, each retailer can have its own pair of secure ID and a validation ID for the memory 104 and corresponding media key 290.

The foregoing embodiments of the media key 200-290 can be used as pass-through mechanisms to a supplier's processing equipment. That is, said media keys do not have to perform intervening processing on the media types stored in the memory 104. Moreover, the second port of said media keys can be designed with an industry-wide interface (as describe above) to readily couple to existing processing equipment of suppliers without having to redesign the processing equipment of said suppliers. Thus, said media keys can be very inexpensive, and can couple to existing processing equipment thereby accelerating its commercial distribution and use by suppliers and third party users. In addition, the media key embodiments for coupling to a digital camera 120 of the present invention is starkly different from prior art reference noted earlier, which teaches the processing of images with complex and expensive intermediate equipment before supplying said images to a conventional photo-processing equipment of a retailer.

It should be apparent to an artisan with skill in the art that there are innumerous embodiments for coupling an alternate device, a media key, and a media device 100. For example, the above embodiments can be modified so that the media device 100 and the alternate device are physically coupled to each other, while the media key and the media device 100 are wirelessly coupled (a variant of FIG. 12). Similarly, the media key and the alternate device can be physically coupled to each other, while the media device 100 is wirelessly coupled to the media key (a variant of FIG. 13). Moreover, it should be evident that there are numerous embodiments (physical and/or logical) to represent security information for enabling access to the memory 104. It would therefore be obvious to said artisan that modifications and/or additions to the foregoing embodiments for engaging an alternate device, the media key and the media device 100 are representative of the spirit and scope of the claimed invention.

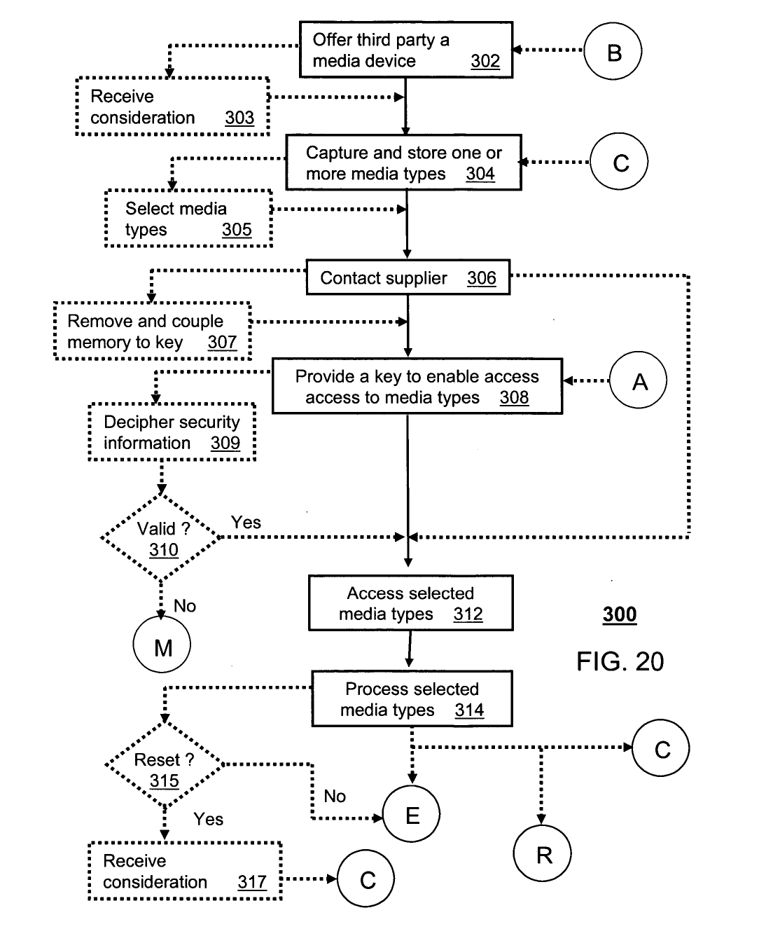

FIGS. 20-22 depict flowcharts with alternate embodiments of a method 300 for utilizing the media device 100 according to the present invention. These flowcharts represent a method for conducting business realized by the acts of the parties and the operations of the devices described therein. The proceeding descriptions will refer to the terms “supplier” and “third party” in singular and plural forms. The term “supplier” should be interpreted broadly, and can include without limitation a vendor, an employer, a principal, or an agent of said principal. Similarly, the term third party has a broad meaning that includes, but is not limited to, a consumer, an employee, or an agent of a principal.

Bearing in mind the broad meaning of these terms, method 300 begins with step 302 where a supplier offers a third party a media device 100. This step can be implemented, for example, in a retail vendor-consumer setting or an industrial employer-employee setting. In a supplemental embodiment, step 302 can be followed by step 303 whereby the third party provides the supplier consideration for the media device. Consideration can be any form of material value the third party can provide the supplier. The supplier's offer in step 302 can represent an equipment rental with consideration, an exchangeable purchase with consideration, or a purchase discounted according to the frequency of the third party engaging in business with the supplier. Alternatively, where the supplier offers a purchase of the media device 100 for no initial consideration from the third party, step 303 can be removed.

In step 304, the third party captures and stores in the memory 104 of the media device 100 one or more media types. The media types can be any form of recordable information captured by any one or more of the embodiments of the media module 102 described above. Once the third party is satisfied with the media types captured, the third party can proceed to step 306 where he or she contacts the supplier for processing a selection of said media types. The selection of the captured media types can be realized by computer instructions embedded in the media device 100, which can provide the third party a visual means such as a UI (User Interface) with corresponding menus for selecting said media types. Alternatively, the supplier can perform the selection with similar means provided by the media device 100 or by accessing all of the media types and making a selection therefrom under the instructions of the third party. It would be obvious to an artisan with skill in the art that any means for selecting said media types is suitable for the claimed invention.

Returning to the contact step 306, the third party can in a first embodiment return to a location of the supplier for processing said media types. Alternatively, the third party can submit a request to the supplier over a first communication network. The first communication network can be a conventional wired network such as PSTN (Public Switched Telephone Network) or a conventional wireless network such as a cellular system. The request can be supplied verbally by the third party calling the supplier by way of the PSTN, or electronically transmitted from the media port 106 by way of a tethered electrical interface coupled to the Internet, or wirelessly over, for example, a cellular network.

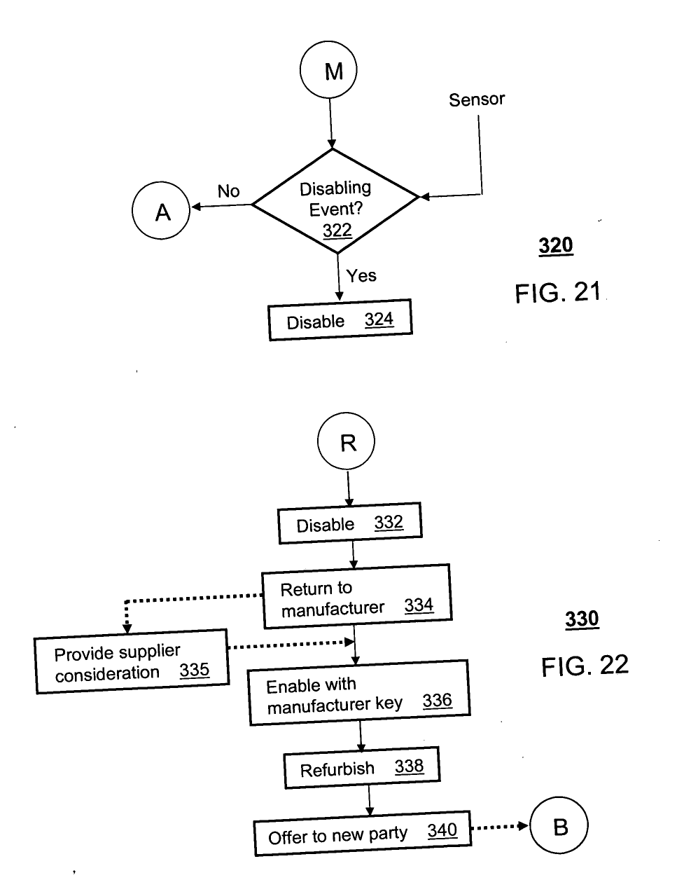

Upon contacting the supplier, the supplier provides in step 308 a key to enable access to the one or more media types stored in the memory 104 of the media device 100. The supplier can provide said key in person when the third party enters the supplier's facility, or can transmit the key over-the-air, or by conventional wired means to the media port 106. The security information of the key can be accompanied by a request to provide access to the selection of media types in the memory 104, and/or a request to disable the media device 100 (this latter request will be described below in the flowcharts of FIGS. 21-22). In a supplemental embodiment, the third party in step 307 supplies the removable memory 104 with the proprietary interface for coupling to the supplier's key for enabling access to the media contents therein. Upon enabling access to the memory 104, in step 312, the media device 100 supplies the selected media types for processing by the supplier in step 314. The selected media types can be transmitted by way of physical coupling, or wireless (short-range or long-range) coupling as described in the embodiments of FIGS. 8-19.

In a supplemental embodiment, the media device 100 includes computer instructions for deciphering the security information (such as the secure ID referred to above) provided to the key in step 309, and for validating with, for example, the validation ID said security information in step 310. If the security key is recognized as valid, then the media device 100 enables access to the memory 104 in step 312 for processing by the supplier in step 314. If the security key is invalid, the media device 100 proceeds to step 322 to determine if a disabling event has occurred which warrants disabling of the media device 100 in step 324. If a disabling event has not occurred, the media device 100 returns to step 308.

In addition to detecting an invalid media key, method 320 can be invoked by receiving a signal from the supplier requesting disablement of the media device 100. The sensor 110 and/or the media port 106 can receive this signal wirelessly or by other suitable communication means. Moreover, the sensor 110 can independently detect altering of the housing assembly, attempts to misappropriate contents of the memory 104 without a valid security key, exceeding a prescribed use period of the media device 100 set by the supplier, and/or violating use guidelines established by the supplier. These triggering events can be implemented in the media device 100 with computer instructions and/or conventional hardware techniques sensing misuse of the media device 100.

The supplier can establish suitable thresholds for allowing multiple attempts before invoking the disabling step 324. Moreover, method 320 can be interrupt driven. That is, it can operate independently from the operation of method 300 as a background process that is invoked the moment a potential disabling event is triggered. Once the media device 100 has been disabled in step 324 it is rendered inoperable and can only be reactivated by a possessor of the security key. Said possessor can be the supplier and/or manufacturer of the media device 100.

Referring back to FIG. 20, it should be evident that the providing and accessing steps 308 and 312, respectively, can be implemented over a second communication network such as a PSTN or wireless communication network by submitting an electronic key to the media device 100, which in turn enables access to the selected media types. In this embodiment, if long-range communication means are used the third party can provide the supplier access to the media types without entering the business facility of the supplier. If short-range communication means are used with a wireless key, the third party can enter the business facility of the supplier and avoid physical coupling with the processing apparatus of the supplier. This embodiment is consistent with the representations of FIGS. 11, 16 and 19.

Once the media types have been accessed, the supplier can in a first embodiment process the selected media types in step 314 utilizing conventional processing equipment. Alternatively, the processing step 314 can represent a visual or automated examination of the media types by the supplier. This latter embodiment can be useful in an industrial setting. For example, the media device 100 can be a GPS monitoring device provided to a truck driver for monitoring driving routes of said employee. Using a security key possessed only by the employer, the employer can periodically enable access to the memory 104 of the media device to retrieve the captured location information. Depending on the sophistication of the location information captured, the employer can visually inspect the information retrieved from the memory 104 without modification, or by way of a mapping application determine the driver's driving behavior. The security key and the misuse detection method 320 prevent the driver from tampering with the media device 100 provided by the employer.

In a commercial vendor-consumer setting the processing step 314 can be accompanied with the consumer providing consideration for processing of the selected media types. A relevant illustration of this can be a vendor offering consumers a media device 100 such as a camera 120 with a secure memory 104 accessible according to one of the security key techniques described in FIGS. 8-19. Because of the media key, the consumer can only process the images captured by the camera 120 with the supplier's processing equipment. Accordingly, method 300 in this context can be used by the vendor as a business method for inducing consumer loyalty. The vendor in turn can offer business incentives such as offering the camera 120 at no initial consideration in anticipation of the consumer processing images only at the vendor's business. In addition, the vendor can provide discounted consideration according to the consumer's frequency of processing media types with the vendor.

Once step 314 is completed, step 314 and subsequent steps of method 300 can be applied for two or more use cycles unconstrained by the supplier of the media device 100. That is, the third party user of the media device 100 can continue to use the media device 100 without requiring physical or logical intervention by the supplier to enable subsequent use cycles of the media device 100. For example, a consumer of the camera 120 incorporating the embodiments of the media device 100 described herein can process photographs with the vendor of said device 100 without requiring the vendor to re-enable the media device 100 for subsequent use cycles. This is a substantial departure from prior art systems mentioned earlier. For example, consumers in said prior art systems are required to provide consideration to acquire a (physical or electrical) reset token for enabling subsequent cycles of a single use digital camera. In the present invention, such intervention by the supplier (vendor) is not required for any of the media types described above. Hence, the components and methods applied to the media device 100 can have unlimited use without vendor intervention, while at the same time providing said supplier a means for establishing a loyalty program with the third party.

In an alternative embodiment, portions of the components of the media device 100, media key 200-290, and/or methods applied thereto can be modified to limit the use of said media device 100 to a single use cycle for all media types excluding still images. For example, a media device 100 such as the video camera 130 can be designed for a single use-cycle. In the present context, single use-cycle can mean a limited period of time, and/or a limited use of the functionalities of the media device 100. Accordingly, the video camera 130 can be limited by battery life, memory capacity to store video images with accompanying audio, a timer limiting length of use, or some other constraint provided by the supplier. Hence, the steps of method 300 described above can be limited to a single use-cycle as illustrated by the end point “E”.

In a supplemental embodiment, the single use cycle can be reset in step 315 so as to restart a subsequent single use cycle of method 300 in whole or in part. The reset step 315 can be performed singly or in combination as a logical, wireless, mechanical, and/or electromechanical reset. The reset function can be included in the media key embodiments 200-290, or alternatively as a conventional technological means provided elsewhere in the media device 100 such as, for example, in the media port 106. The reset function can be protected by a secure ID with encryption to avoid misappropriated use of the media device 100. Where the supplier-third party relationship is a vendor-consumer relationship, the reset step 315 can be followed by step 317 where the consumer provides consideration to the vendor for a reset request. Additionally, method 300 can be modified so that the consumer can purchase a number of resets in one transaction, and invoke therefrom resets independent of the vendor. This may be done through secure software applications provided by the vendor, reset codes supplied to the media device 100 or other means for a consumer to securely purchase and execute reset cycles. Once the reset function is properly initiated in step 315, the steps of method 300 are reinitiated at the entry point denoted by the symbol “C”.

In yet another alternate embodiment, a portion of the components of the media device 100 and/or methods applied thereto can be limited to a single use cycle without the need for a media key to access the contents of the memory 104. In this embodiment, the media device 100 can capture all media types excluding still image information. Method 300 can be applied to this embodiment with the exception of step 308, which is bypassed as shown in FIG. 20. Accordingly, the one or more media types stored in the memory 104 can be accessed without a secure key. The single use limitations described above can be applied in this embodiment, thereby serving to preserve third party loyalty with the supplier. Additionally, the single use cycle can be restarted by step 315 as previously described.

In another alternate embodiment, a portion of the components of the media device 100, media key 200-290, and/or methods thereof can be used for a plurality of use cycles, or alternatively, can be limited to a single use cycle with resetable single use cycles as described earlier. In this embodiment, the media device 100 can capture all media types without limitation. Additionally, any embodiments of the memory 104, and any of the foregoing embodiments of the media key 200-290 can be used to couple at a first port to the memory 104 and to a final processing means at the second port. The first port as described earlier enables access the contents of the memory 104 and supplies said contents at the second port. The one or more media types of the memory 104 traverse both ports of said key without modification. Although said media types remain unmodified while traversing the media key, the media key can, however, employ security algorithms to protect access to the media types. For example, the media key and memory 104 can use a secure ID and validation ID as described earlier to assure the proper supplier and third party are enabling access to the media types.

Additionally, the media types may be encrypted in the memory 104. Thus when the media key receives the encrypted media types it can decrypt said media types without modification to the raw content of said media types. That is, the media key will not perform algorithmic processing on the media types to enhance value. For example, in the case of image files (e.g., JPEG) the media key does not perform any processing on said images to enhance, for example, contrast, brightness, color, redeye, or other like adaptations typically performed by conventional image processing software. Accordingly, the final processing means (e.g., a photo processor) of the supplier is the final point of processing for the third party user. That is, the final processing means is used for processing said media types in their final format (e.g., photographic paper, DVD, CD, or other format). The media key therefore supports data transfers to a final processing means without intermediate processing on said media types.

Any of the aforementioned embodiments of method 300 can be further supplemented with a method 330 for refurbishing the media device 100. In this embodiment, step 314 is followed by step 332 where the supplier disables the media device 100. Following this step, the media device 100 is rendered inoperable and can only be reactivated by a security key possessed by the manufacturer of said media device 100. Upon disabling the media device 100 in step 332, the supplier returns the unit to the manufacturer in step 334. In an alternate embodiment, the manufacturer can provide the supplier in step 335 consideration for returning the media device 100 for refurbishment. Consideration in the present context can mean, but is not limited to, a rebate corresponding to a portion of an original purchase price paid by the supplier, a credit applied to a future purchase by the supplier of the refurbished media device or a different media device, or a discount applied to a future purchase by the supplier of the refurbished media device or a different media device.

In step 336, the manufacturer enables the media device 100 with the manufacturer's key, and begins refurbishment of the device in step 338. Refurbishing in the present context can mean singly or in combination partial or whole replacement of components of the media device 100 with enhanced or similar components, cleaning and inspection of components of the media device 100, addition of components to enhance the capability of the media device, and repackaging of the refurbished media device 100. Once the media device 100 has been refurbished, it can be offered in step 340 to a party including, but not limited to, the supplier who provided the media device 100 for refurbishment, an agent of said supplier, or a new supplier.

It should be evident to the reader by now that the present invention can be realized in hardware, software, or a combination thereof. Additionally, the present invention can be embedded in a computer program of the media device 100 and/or the media key, which comprises all the features enabling the implementation of the methods described herein, and which enables said devices to carry out these methods. A computer program in the present context means any expression, in any language, code or notation, of a set of instructions intended to cause a system having an information processing capability to perform a particular function either directly or after either or both of the following: a) conversion to another language, code or notation; b) reproduction in a different material form. Additionally, a computer program can be implemented in hardware as a state machine without conventional machine code as is typically used by CISC (Complex Instruction Set Computers) and RISC (Reduced Instruction Set Computers) processors.

It should also be evident that the present invention may be used for many applications. Thus, although the description is made for particular arrangements and methods, the intent and concept of the invention is suitable and applicable to other arrangements and applications not described herein. For example, the above descriptions refer to business methods for inducing consumer loyalty, refurbishing media devices, and managing media devices with employees, just to mention a few. Other business activities can make use of the aforementioned embodiments of the media device 100 and corresponding keys without departing from the claimed invention. It would be clear therefore to those skilled in the art that modifications to the disclosed embodiments described herein can be effected without departing from the spirit and scope of the invention.

Accordingly, the described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description are to be construed to be inclusive of the scope of the invention as defined in the following claims. Thus, reference should be made to the following claims, rather than to the foregoing specification, as indicating the scope of the invention.

What is claimed is:

1. A method for securely retrieving data captured by a media device, comprising the steps of:
a supplier, offering to a third party a media device;
the third party,
capturing one or more media types with the media device;
contacting the supplier to process a selection of the one or more media types;
the supplier,
providing a key to enable access to the one or more media types stored in the media device;
accessing the selection of the one or more media types;
processing the selection of the one or more media types; and
applying the capturing, contacting, providing, accessing and processing steps for a plurality of use-cycles unconstrained by a supplier of said device.

2. The method of claim 1, wherein the supplier comprises at least one among a group of suppliers comprising a vendor, an employer, a principal, and an agent of the principal, and wherein the third party comprises at least one among a group of third parties comprising a consumer, an employee, and an agent of a principal.

3. The method of claim 1, further comprising the step of the third party providing the supplier consideration for processing the selection of the one or more media types.

4. The method of claim 3, wherein said consideration is discounted according to the frequency of processing media types with the supplier.

5. The method of claim 1, wherein the key is at least one of a group of keys comprising a key for physically engaging with the media device and a key for wirelessly engaging with the media device.

6. The method of claim 1, wherein the contacting step comprises the step of returning to a location of the supplier for processing the selection of the one or more media types.

7. The method of claim 1, wherein the contacting step comprises the step of submitting over a first communication network a request to the supplier for processing the selection of the one or more media types, and wherein the providing and accessing steps comprise the steps of transmitting over a second communication network an electronic key to the media device for enabling access to the selection of the one or more media types, and receiving over the second communication network the selection of the one or more media types.

8. The method of claim 7, wherein the request is supplied by the third party verbally to the supplier over the first communication network.

9. The method of claim 7, wherein each of the first and second communication networks comprise at least one among a group of communication networks comprising a PSTN (Public Switched Telephone Network) and a wireless communication network.

10. The method of claim 1, wherein the offering step includes at least one among a group of offers comprising a purchase with no initial consideration from the third party, an equipment rental with consideration from the third party, an exchangeable purchase with consideration from the third party, and a purchase discounted according to a frequency of the third party engaging in business with the supplier.

11. The method of claim 1, wherein the accessing step further comprises the step of coupling the media device to an alternate device of the supplier for processing the selection of the one or more media types.

12. The method of claim 1 1, wherein the coupling step comprises at least one among a group of coupling techniques comprising:
a physical coupling between the media device, the key and the alternate device;
a physical coupling between the media device and the key, and a wireless coupling with the alternate device;
a physical coupling between the media device and the alternate device, and a wireless coupling to the key;
a physical coupling between the key and the alternate device, and a wireless coupling to the media device; and
a wireless coupling between the media device, the key, and the alternate device.

13. The method of claim 1, wherein the one or more media types comprise recordable information from one or more information sources.

14. The method of claim 13, wherein the one or more information sources comprise at least one among a group of information sources comprising location information, environmental information, medical information, public information, instrumentation information, commercial information, audio information, still image information, moving image information, still image information combined with audio information, and moving image information combined with audio information.

15. The method of claim 1, wherein the one or more media types can be accessed only by a possessor of the key.

16. The method of claim 15, wherein the possessor of the key is at least one among a group of possessors comprising the supplier, a manufacturer of the media device, and agents thereof.

17. The method of claim 1, further comprising the steps of:
the third party, returning the media device to the supplier for refurbishment;
the supplier,
disabling the media device with the key;
returning the media device to a manufacturer of said media device;
the manufacturer,
enabling the media device with a key of said manufacturer;
refurbishing the media device; and
offering the refurbished media device to a party.

18. The method of claim 17, wherein the party is at least one among a group of parties comprising the supplier, an agent of the supplier, and a new supplier.

19. The method of claim 17, wherein after the disabling step the media device can only be enabled with the key of the manufacturer.

20. The method of claim 17, further comprising the step of the manufacturer providing consideration to the supplier returning the media device.

21. The method of claim 20, wherein said consideration includes at least one among a group of considerations comprising a rebate corresponding to a portion of an original purchase price paid by the supplier, a credit applied to a future purchase by the supplier of the refurbished media device or a different media device, and a discount applied to a future purchase by the supplier of the refurbished media device or a different media device.

22. The method of claim 17, wherein the refurbishing step includes at least one among a group of refurbishing techniques comprising partial or whole replacement of components of the media device with enhanced or similar components, cleaning and inspection of components of the media device, addition of components to enhance the capability of the media device, and repackaging of the refurbished media device.

23. The method of claim 1, further comprising the step of disabling the media device upon detecting at least one among a group of events comprising altering the media device, accessing the stored media types without the key, exceeding a prescribed use period set by the supplier, violating use guidelines for the media device set by the supplier, and receiving a request from the supplier to disable the media device.

24. The method of claim 23, wherein a disabled media device is rendered inoperative.

25. The method of claim 23, wherein a disabled media device is rendered operable by providing at least one among a group comprising the key of the supplier, and a key of a manufacturer of the media device.

26. The method of claim 1, further comprising the steps of:
removing a storage medium of the media device; and
coupling the storage medium with the key to enable access to the one or more media types.

27. The method of claim 26, wherein the key is at least one of a group of keys comprising a key for physically engaging with the storage medium and a key for wirelessly engaging with the storage medium.

28. The method of claim 26, wherein the key comprises a standard interface to supply the one or more media types from the storage medium to an alternate device of the supplier.

29. A media device, comprising:
a media module for capturing one or more media types;
a memory coupled to the media module for securely storing the captured one or more media types;
a media port coupled to the memory for providing an alternate device access to a selection of the one or more securely stored media types after detecting a valid security key; and
a housing assembly for carrying the components of the media device, wherein the aforementioned components of the media device have a plurality of use-cycles unconstrained by a supplier of said device.

30. The media device of claim 29, wherein the media port provides the alternate device access to the memory by way of the security key.

31. The media device of claim 30, wherein a first end of the security key engages with the media port and a second end engages with the alternate device.

32. The media device of claim 31, wherein the first end couples to the memory by way of the media port, and wherein the second end has a form factor and an electrical interface for coupling with the alternate device.

33. The media device of claim 32, wherein the form factor and the electrical interface comprise at least one among a group comprising an SD (Secure Digital) interface, a MMC (Multi Media Card) interface, a Smart Media card interface, a CompactFlash card interface, a TransFlash card interface, a USB (Universal Serial Bus) interface, a FireWire interface, and an Ethernet interface.

34. The media device of claim 29, wherein the memory is a non-volatile memory.

35. The media device of claim 29, wherein the housing assembly prevents access to the memory.

36. The media device of claim 29, wherein the media module captures recordable information from one or more information sources.

37. The media device of claim 36, wherein the one or more information sources comprise at least one among a group of information sources comprising location information, environmental information, medical information, public information, instrumentation information, commercial information, audio information, still image information, moving image information, still image information combined with audio information, and moving image information combined with audio information.

38. The media device of claim 29, wherein the media module comprises at least one among a group of recordable devices comprising an instrument for monitoring location, a measurement instrument, a sensing instrument, a health monitoring instrument, a commercial operations monitoring instrument, a public monitoring instrument, an audio capture instrument, an image capture instrument, and an image combined with audio capture instrument.

39. The media device of claim 29, further comprising a sensor for detecting events that trigger disablement of the media device.

40. The media device of claim 39, wherein the events comprise at least one among a group comprising altering the housing assembly, accessing the memory with an invalid security key, exceeding a predetermined use period set by the supplier, violating use guidelines set by the supplier, and receiving a signal from the supplier at one among a group comprising the sensor and the media port to disable the media device.

41. The media device of claim 39, wherein at least one among the sensor and the media port is wireless, and wherein one among the sensor and the media port can detect a wireless signal from the supplier requesting disablement of the media device.

42. The media device of claim 39, wherein a disabled media device is rendered inoperative.

43. The media device of claim 39, wherein a disabled media device is rendered operable by coupling with at least one among a group comprising the valid security key of a supplier of the media device, and a valid security key of a manufacturer of the media device.

44. The media device of claim 29, wherein the media port is at least one among a group comprising a wireless interface and a wired interface for coupling to the security key and the alternate device

45. The media device of claim 29, wherein the media port comprises a mechanical lock which when engaged with the key enables access to the memory, and wherein the memory further comprises a means for providing the alternate device access to the selection of the one or more media types.

46. The media device of claim 29, wherein the media port is an integral part of the memory, and wherein the memory is removable.

47. The media device of claim 46, wherein the media port comprises an undisclosed interface for coupling to an undisclosed mating interface of the security key, and wherein the coupling of said interfaces enables access to the one or more media types.

48. The media device of claim 46, wherein the memory comprises a pre-stored secure ID, and wherein the security key couples to the memory to validate the secure ID, and if valid provides the alternate device access to the one or more media types.

49. The media device of claim 46, wherein the key is at least one of a group of keys comprising a key for physically engaging with the memory and a key for wirelessly engaging with the memory.

50. A media device, comprising:
a media module;
a media port;
a memory;
a processor for controlling operation of the media module, the media port and the memory; and
a housing assembly for carrying the components of the media device, wherein the processor is programmed to:
capture one or more media types with the media module;
store the one or more media types in the memory;
restrict access to retrieve the one or more media types in the memory;
detect a valid security key at the media port;
provide an alternate device access to the selection of the one or more media types in the memory after determining the security key is valid; and
apply the foregoing steps for a plurality of use-cycles unconstrained by a supplier of said device.

51. A media key, comprising:
a first port for enabling access to one or more media types stored in a media device having a plurality of use-cycles unconstrained by a supplier of said device; and
a second port for supplying the one or more media types.

52. The media key of claim 51, wherein the second port is an integral part of the media device.

53. The media key of claim 51, wherein the first port is one among a group comprising:
a keyed implement for physically engaging and unlocking a corresponding locking implement of the media device;
an implement having one or more electrical components with exposed contacts for providing security information to the media device upon physically engaging with corresponding electrical contacts of the media device;
an implement having one or more electrical components for providing wireless security information to the media device upon physically engaging and unlocking a corresponding locking implement of the media device; and
a wireless key for supplying the media device wireless security information.

54. The media key of claim 51, wherein the second port is one among a group comprising an implement having a form factor and an electrical interface, and a wireless interface.

55. The media key of claim 54, wherein the form factor and the electrical interface comprises at least one among a group comprising an SD (Secure Digital) interface, a MMC (Multi Media Card) interface, a Smart Media card interface, a CompactFlash card interface, a TransFlash card interface, a USB (Universal Serial Bus) interface, a FireWire interface, and an Ethernet interface.

56. The media key of claim 5 1, further comprising a component for supplying security information to the media device for enabling access to the one or more media types.

57. The media key of claim 56, wherein the component is at least one among a group comprising a memory with the security information stored therein, and a memory coupled to a processor for supplying the security information stored in the memory.

58. The media key of claim 51, wherein the media device is a digital camera comprising a memory for storing the one or more the media types as image files, and wherein the media key further comprises a pass-through connector for supplying the unadulterated one or more image files in the memory to a photo finishing lab of a supplier of the media device.

59. A media device having a computer-readable storage medium, comprising computer instructions for:
capturing one or more media types with a media module of the media device;
storing the one or more media types in a memory of the media device;
accepting a key at a media port of the media device to enable access to a selection of the one or more media types;
supplying an alternate device coupled to the media device the selection of the one or more media types, and
applying the foregoing steps for a plurality of use-cycles unconstrained by a supplier of said device.

60. The storage medium of claim 59, further comprising computer instructions for providing at least one among a user and a supplier of the media device a means for selecting the one or more media types.

61. The storage medium of claim 59, wherein the key is at least one among a group of keys comprising a key for physically engaging with the media port and a key for wirelessly engaging with the media port, and wherein the storage medium further comprises computer instructions for processing information from engagement of the media port and the key.

62. The storage medium of claim 59, wherein the accessing step further comprises computer instructions for coupling the media device to an alternate device of the supplier for processing the selection of the one or more media types.

63. The storage medium of claim 62, wherein the coupling step comprises at least one among a group of coupling techniques comprising:
a physical coupling between the media device, the key and the alternate device;
a physical coupling between the media device and the key, and a wireless coupling to alternate device;
a physical coupling between the media device and the alternate device, and a wireless coupling to the key;
a physical coupling between the key and the alternate device, and a wireless coupling to the media device;
a wireless coupling between the media device, the key, and the alternate device.

64. The storage medium of claim 59, further comprising computer instructions for controlling operations of the media module to capture recordable information from one or more information sources, wherein the one or more information sources comprise at least one among a group of information sources comprising location information, environmental information, medical information, public information, instrumentation information, commercial information, audio information, still image information, moving image information, still image information combined with audio information, and moving image information combined with audio information.

65. The storage medium of claim 59, further comprising computer instructions for:
disabling the media device with the key of a supplier; and
enabling the media device with the key of a manufacturer of said media device.

66. The storage medium of claim 59, further comprising computer instructions for disabling the media device upon detecting with a sensor of the media device at least one among a group of events comprising altering the media device, accessing the stored media types without the key, exceeding a predetermined use period set by a supplier, violating use guidelines set by the supplier, and receiving a request from the supplier to disable the media device.

67. The storage medium of claim 59, further comprising computer instructions for:
deciphering security information provided by the key; and
determining whether the security information is valid.

68. The storage medium of claim 67, further comprising computer instructions for providing the alternate device access to the selection of the one or more media types in the memory after determining the security information is valid.

69. The storage medium of claim 67, further comprising computer instructions for processing a request provided by the key, wherein the request is at least one among a group of requests comprising a request for accessing the selection of the one or more media types, and a request for disabling the media device.

70. The storage medium of claim 59, wherein the media port further comprises at least one among a group comprising a wireless interface and a wired interface for communicating with a communication network, and wherein the storage medium further comprises computer instructions for contacting a supplier of the media device by way of the media port.

71. The storage medium of claim 70, wherein the contacting step comprises computer instructions for:
transmitting a request to the supplier for processing the selection of the one or more media types;
receiving the key from the supplier for said processing; and
transmitting the selection of the one or more media types to the supplier.

72. A media key having a computer-readable storage medium, comprising computer instructions for:
enabling through a first port of the media key access to one or more media types stored in a media device having a plurality of use-cycles unconstrained by a supplier of said device; and
supplying through a second port of the media key the one or more media types supplied by the media device.

73. The storage medium of claim 72, further comprising computer instructions for supplying the one or more media types to an alternate device through the second port.

74. The storage medium of claim 72, further comprising computer instructions for supplying a request to the media device through the first port.

75. The storage medium of claim 74, wherein the request is at least one among a group of requests comprising a request for providing an alternate device access to the one or more media types, a request for selecting the one or more media types, and a request for disabling the media device.

76. The storage medium of claim 72, wherein at least one among the first and second ports includes a wireless interface, and wherein the storage medium further comprising computer instructions for processing wireless signals on said ports.

77. The storage medium of claim 72, wherein a removable memory of the media device is coupled to the first port of the media key, and wherein the one or more media types of the media device are stored in the removable memory.

78. The storage medium of claim 77, wherein the enabling and supplying steps further comprise computer instructions for:
retrieving a secure ID from the removable memory;
comparing said secure ID to a validation ID stored in said media key; and
supplying the one or more media types stored in the removable memory when the secure ID matches the validation ID.

79. The storage medium of claim 77, wherein the second port comprises a standard interface to supply the one or more media types from the removable memory to an alternate device of a supplier of the media device.

80. A method for securely retrieving data captured by a media device, comprising the steps of:
a supplier, offering to a third party a media device;
the third party,
capturing one or more media types with the media device, wherein the one or more media types comprise recordable information from one or more information sources excluding still image information;
contacting the supplier to process a selection of the one or more media types;
the supplier,
providing a key to enable access to the one or more media types stored in the media device;
accessing the selection of the one or more media types; and
processing the selection of the one or more media types.

81. The method of claim 80, wherein the one or more information sources comprise at least one among a group of information sources comprising location information, environmental information, medical information, public information, instrumentation information, commercial information, audio information, moving image information, moving image information combined with audio information.

82. The method of claim 80, wherein a portion of the foregoing steps are limited to a single use cycle.

83. The method of claim 82, further comprising the step of resetting the single use cycle so as to restart a subsequent single use cycle of the portion of the foregoing steps.

84. The method of claim 83, further comprising the step of the third party providing the supplier consideration for the resetting step.

85. A media device, comprising:
a media module for capturing one or more media types, wherein the one or more media types comprise recordable information from one or more information sources excluding still image information;
a memory coupled to the media module for securely storing the captured one or more media types;
a media port coupled to the memory for providing an alternate device access to a selection of the one or more securely stored media types after detecting a valid security key; and
a housing assembly for carrying the components of the media device.

86. The media device of claim 85, wherein the one or more information sources comprise at least one among a group of information sources comprising location information, environmental information, medical information, public information, instrumentation information, commercial information, audio information, moving image information, moving image information combined with audio information.

87. The media device of claim 85, wherein a portion of the foregoing components of the media device are limited to a single use cycle.

88. The media device of claim 87, wherein the single use cycle is resettable so as to restart a subsequent single use cycle of the portion of the foregoing components of the media device.

89. A media device having a computer-readable storage medium, comprising computer instructions for:
capturing one or more media types with a media module of the media device, wherein the one or more media types comprise recordable information from one or more information sources excluding still image information;
storing the one or more media types in a memory of the media device;
accepting a key at a media port of the media device to enable access to a selection of the one or more media types; and
supplying an alternate device coupled to the media device the selection of the one or more media types.

90. The storage medium of claim 89, wherein the one or more information sources comprise at least one among a group of information sources comprising location information, environmental information, medical information, public information, instrumentation information, commercial information, audio information, moving image information, moving image information combined with audio information.

91. The storage medium of claim 88, wherein a portion of the foregoing computer instruction steps are limited to a single use cycle.

92. The storage medium of claim 91, further comprising computer instructions for resetting the single use cycle so as to restart a subsequent single use cycle of the portion of the foregoing computer instruction steps.

93. A method for retrieving data captured by a media device, comprising the steps of:
a supplier, offering to a third party a media device;
the third party,
capturing one or more media types with the media device, wherein the one or more media types comprise recordable information from one or more information sources excluding still image information;
contacting the supplier to process a selection of the one or more media types;
the supplier,
accessing the selection of the one or more media types; and
processing the selection of the one or more media types, wherein a portion of the foregoing steps are limited to a single use cycle.

94. The method of claim 93, wherein the one or more information sources comprise at least one among a group of information sources comprising location information, environmental information, medical information, public information, instrumentation information, commercial information, audio information, moving image information, moving image information combined with audio information.

95. The method of claim 93, further comprising the step of resetting the single use cycle so as to restart a subsequent single use cycle of the portion of the foregoing steps.

96. The method of claim 95, further comprising the step of the third party providing the supplier consideration for the resetting step.

97. A media device, comprising:
a media module for capturing one or more media types, wherein the one or more media types comprise recordable information from one or more information sources excluding still image information;
a memory coupled to the media module for storing the captured one or more media types;
a media port coupled to the memory for providing an alternate device access to a selection of the one or more stored media types; and
a housing assembly for carrying the components of the media device, wherein a portion of the foregoing components are limited to a single use cycle.

98. The media device of claim 97, wherein the one or more information sources comprise at least one among a group of information sources comprising location information, environmental information, medical information, public information, instrumentation information, commercial information, audio information, moving image information, moving image information combined with audio information.

99. The media device of claim 97, wherein the single use cycle is resettable so as to restart a subsequent single use cycle of the portion of the foregoing components of the media device.

100. A media device having a computer-readable storage medium, comprising computer instructions for:
capturing one or more media types with a media module of the media device, wherein the one or more media types comprise recordable information from one or more information sources excluding still image information;
storing the one or more media types in a memory of the media device; and
supplying an alternate device coupled to the media port a selection of the one or more media types, wherein a portion of the foregoing computer instructions are limited to a single use cycle.

101. The storage medium of claim 100, wherein the one or more information sources comprise at least one among a group of information sources comprising location information, environmental information, medical information, public information, instrumentation information, commercial information, audio information, moving image information, moving image information combined with audio information.

102. The storage medium of claim 100, further comprising computer instructions for resetting the single use cycle so as to restart a subsequent single use cycle of the portion of the foregoing computer instruction steps.

103. A method for securely retrieving data captured by a media device, comprising the steps of:
a supplier, offering to a third party a media device;
the third party,
capturing one or more media types with the media device;
contacting the supplier to process a selection of the one or more media types;
the supplier,
providing a key to enable access to the one or more media types stored in the media device;
accessing through the key the selection of the one or more media types without modifying said media types while traversing said key; and
processing at a final processing means coupled to the key the selection of the one or more media types.

104. The method of claim 103, wherein the one or more media types comprise recordable information from one or more information sources, and wherein the one or more information sources comprise at least one among a group of information sources comprising location information, environmental information, medical information, public information, instrumentation information, commercial information, audio information, still image information, moving image information, still image information combined with audio information, and moving image information combined with audio information.

105. The method of claim 103, wherein a portion of the foregoing steps are limited to a single use cycle.

106. The method of claim 105, further comprising the step of resetting the single use cycle so as to restart a subsequent single use cycle of the portion of the foregoing steps.

107. A media device, comprising:
a media module for capturing one or more media types;
a memory coupled to the media module for securely storing the captured one or more media types;
a media port coupled to the memory and to a key for providing a final processing means coupled to the key access to a selection of the one or more securely stored media types without modifying said media types while traversing said key; and
a housing assembly for carrying the components of the media device.

108. The media device of claim 107, wherein the one or more media types comprise recordable information from one or more information sources, and wherein the one or more information sources comprise at least one among a group of information sources comprising location information, environmental information, medical information, public information, instrumentation information, commercial information, audio information, still image information, moving image information, still image information combined with audio information, and moving image information combined with audio information.

109. The media device of claim 107, wherein a portion of the foregoing components of the media device are limited to a single use cycle.

110. The media device of claim 109, wherein the single use cycle is resettable so as to restart a subsequent single use cycle of the portion of the foregoing components of the media device.

111. A media device having a computer-readable storage medium, comprising computer instructions for:
capturing one or more media types with a media module of the media device;
storing the one or more media types in a memory of the media device;
accepting a key at a media port of the media device to enable access to a selection of the one or more media types without modifying said media types while traversing said key; and
supplying the final processing means coupled to the key the selection of the one or more media types.

112. The storage medium of claim 111, wherein the one or more media types comprise recordable information from one or more information sources, and wherein the one or more information sources comprise at least one among a group of information sources comprising location information, environmental information, medical information, public information, instrumentation information, commercial information, audio information, still image information, moving image information, still image information combined with audio information, and moving image information combined with audio information.

113. The storage medium of claim 111, wherein a portion of the foregoing computer instruction steps are limited to a single use cycle.

114. The storage medium of claim 113, further comprising computer instructions for resetting the single use cycle so as to restart a subsequent single use cycle of the portion of the foregoing computer instruction steps.

115. A media key, comprising:
a first port for enabling access to one or more media types stored in a media device; and
a second port for supplying the one or more media types to a final processing means without modifying the one or more media types.

116. The media key of claim 115, wherein the second port is one among a group comprising an implement having a form factor and an electrical interface, and a wireless interface.

117. The media key of claim 116, wherein the form factor and the electrical interface comprises at least one among a group comprising an SD (Secure Digital) interface, a MMC (Multi Media Card) interface, a Smart Media card interface, a CompactFlash card interface, a TransFlash card interface, a USB (Universal Serial Bus) interface, a FireWire interface, and an Ethernet interface.

118. The media key of claim 115, further comprising a component for supplying security information to the media device for enabling access to the one or more media types.

119. The media key of claim 118, wherein the component is at least one among a group comprising a memory with the security information stored therein, and a memory coupled to a processor for supplying the security information stored in the. memory.

120. The media key of claim 115, wherein the first port is one among a group comprising:
a keyed implement for physically engaging and unlocking a corresponding locking implement of the media device;
an implement having one or more electrical components with exposed contacts for providing security information to the media device upon physically engaging with corresponding electrical contacts of the media device;
an implement having one or more electrical components for providing wireless security information to the media device upon physically engaging and unlocking a corresponding locking implement of the media device; and
a wireless key for supplying the media device wireless security information.

121. A media key having a computer-readable storage medium, comprising computer instructions for:
enabling through a first port of the media key access to one or more media types stored in a media device; and
supplying through a second port of the media key the one or more media types supplied by the media device to a final processing means without modifying the one or more media types.

122. The storage medium of claim 121, further comprising computer instructions for supplying a request to the media device through the first port, wherein the request is at least one among a group of requests comprising a request for providing the final processing means access to the one or more media types, a request for selecting the one or more media types, a request for disabling the media device, and a request for resetting the media device to activate a subsequent single use cycle.

123. The storage medium of claim 121, wherein at least one among the first and second ports includes a wireless interface, and wherein the storage medium further comprising computer instructions for processing wireless signals on said ports.

124. The storage medium of claim 121, wherein a removable memory of the media device is coupled to the first port of the media key, and wherein the one or more media types of the media device are stored in the removable memory.

125. The storage medium of claim 124, wherein the enabling and supplying steps further comprise computer instructions for:
retrieving a secure ID from the removable memory;
comparing said secure ID to a validation ID stored in said media key; and
supplying the one or more media types stored in the removable memory when the secure ID matches the validation ID.

126. The storage medium of claim 124, wherein the second port comprises a standard interface to supply the one or more media types from the removable memory to the final processing means of a supplier of the media device.
